(19) United States
(12) Patent Application Publication
(10) Pub. No.: US 2003/0010838 A1
(43) Pub. Date: Jan. 16, 2003

(54) Multiple nozzle tip assembly for airless paint sprayer gun

(76) Inventor: Stephen R. Earl, Orem, UT (US)

Correspondence Address: Angus C. Fox, III, 4093 N. Imperial Way, Provo, UT, 84604-5386, US

(21) Appl. No.: 09/904,087

(22) Filed: Jul. 12, 2001

(51) Int. Cl. B05B 1/28

(52) U.S. Cl. 239/104; 239/106; 239/119

(57) ABSTRACT

A spray tip assembly for airless paint sprayer guns incorporates a tip having multiple nozzles, each of which may be used independently. For one embodiment of the invention, the shaft of the spray tip assembly incorporates a pair of spaced apart nozzles and a handle at each end, one of which is removable for insertion into a bore of a spray tip assembly housing. The bore that extends through the housing so as to permit the shaft to axially slide between first and second positions, each of which is limited by one of the handles. For a second embodiment of the invention the shaft of the spray tip assembly incorporates multiple spaced apart nozzles and a handle at one end thereof. The shaft also incorporates a spring-loaded detent ball which, in combination with a plurality of spaced-apart annular or semi-annular grooves in the housing bore, serves as a shaft locator for each of the nozzles. The nozzles may be unclogged by reversing them.

### BACKGROUND OF THE INVENTION

1. Field of the Invention

This invention relates to airless paint sprayers and, more particularly, to the design of tips used in the spray guns of such sprayers.

2. Description of the Prior Art

A typical airless paint sprayer includes a pump, a suction tube having one end coupled to the pump inlet and the free end insertable in a container of paint, and a high-pressure hose that connects the pump outlet to a spray gun. Typically, a check valve is installed at the pump outlet. The spray gun has a trigger which, when depressed, opens a valve to allow pressurized paint in the hose to flow through a nozzle in the gun tip. The paint is atomized as it exits the nozzle, allowing a painter to evenly apply the paint to a surface. Although there are dozens of manufacturers of airless paint spraying equipment, the function of the equipment is basically the same. Differences in the available equipment usually relate to the design and output capacity of the pump. The three most common types of pumps used in airless paint sprayers are diaphragm pumps, piston pumps and gear pumps.

The capacity of pump unit, the high-pressure hose length, and the number of spray guns connected to the pump unit will determine the maximum tip size. A sprayer having an output capacity of ½ gallon per minute (gpm) can comfortably support a single spray gun using a tip nozzle in the 0.015 to 0.021-inch (about 0.38 to 0.53 mm) diameter range. Required pump capacity increases by about the square of the nozzle size.

Referring now to FIG. 1, a spray gun 100 used in combination with airless paint spraying systems typically has a hollow, pistol-shaped body 101. The body 100 incorporates a handle 102, a squeezable trigger 103, a trigger guard 104, and an internal valve assembly 105, controlled by the trigger 103, that controls the flow of paint to an output barrel 106. The handle 102 typically doubles as a housing for a removable screen filter (not shown). At the bottom of the handle 102 is a threaded coupling 107, to which the high-pressure hose from the pump unit may be attached. Attached to the end 108 of the output barrel 106 is a spray tip assembly 109.

Referring now to FIGS. 2 through 6, a typical spray tip assembly 109 includes a tip housing 201 having, at a first end thereof, a connector 202 that attaches to the end 108 of the output barrel and, at a second end thereof, a spray guard 203 that reduces the possibility of that a user of the equipment will inject paint into his body through the skin. The tip housing 201 generally incorporates a cylindrical bore 204 that is sized to receive a cylindrical shaft 301, that is generally referred to as a spray tip. At the mouth of the cylindrical bore 204 on one side of the tip housing 201 is a semicircular recess 205. When the spray tip assembly 109 is installed on the spray gun 100, the cylindrical bore 204 is perpendicular to the axis 401 of the gun output barrel 106. The cylindrical shaft 301 is sized for slidable entry into the cylindrical bore 204, with minimal clearance so as to prevent leakage of paint between the cylindrical surface of the shaft 301 and the cylindrical surface of the bore 204. For this particular prior art spray tip assembly 109, the cylindrical shaft 301 is secured within the bore 204 with a semicircular spring clip 501.

Still referring to FIGS. 2 through 6, the shaft 301 incorporates a single nozzle 302, the axis of which is perpendicular to the axis 303 of the shaft 301. At one end thereof, the shaft incorporates a handle 304, which facilitates both removal of the of the shaft 301 from the tip housing 201 and rotation of the shaft 301 to reverse the nozzle 302 should it become clogged. The handle 304 may incorporate a stop 305 which, in combination with the semicircular recess 205, allows the shaft 301 to be rotated only within an arc of 180 degrees. At one end of the arc, the nozzle 302 is positioned for spraying; at the other end of the arc, the nozzle 302 is positioned for unclogging.

Professional painters typically use several interchangeable tips of different sizes and/or different spray patterns at the same job site, the size and pattern of the tip being dictated by the particular application. For example, a tip with a 0.035-inch-diameter nozzle might be used for rapid application of latex base coats, while a tip with a 0.015 -inch-diameter nozzle might be used for the painting of trim. In order to change to a different tip, the installed tip must be removed and stored for future use, and the desired tip installed in its place. The need to switch tips affords an opportunity for uninstalled tips to become lost. As the retail cost of each tip is about $US 30, the loss of multiple tips equates to a significant needless expense. There is also an additional economic waste related to the time required to switch out the tips.

What is needed is a spray gun for airless paint sprayers which permits rapid changeover of spray nozzles and reduces the probability that unused spray tips will become lost.

### SUMMARY OF THE INVENTION

The present invention provides a new spray tip assembly that may be used in combination with conventional spray guns for airless paint sprayers. The spray tip assembly incorporates a tip having multiple nozzles, each of which may be used independently. Several embodiments of the invention are contemplated.

A first embodiment of the invention the shaft of the spray tip assembly incorporates multiple spaced apart nozzles and a handle at one end thereof. The shaft also incorporates a spring-loaded detent ball. The tip housing has a bore with a plurality of spaced-apart annular or semi-annular grooves, each of which, in conjunction with the spring-loaded detent ball, serves as a shaft locator for each of the nozzles. The grooves permit positioning of each of the nozzles in either a normal spraying position or in a reversed, unclogging position. Alternatively, the tip housing incorporates three spaced-apart annular channels, all three of which are interconnected by a passageway shaped to admit the stop tab. More accurately, the outermost channel is really a semicircular recess, shown in the prior art description as item 205, as it is open on one side. The stop tab may be indexed with one of the channels 901A, thereby serving to position the shaft 700 so that each of the nozzles may be respectively and independently positioned for use.

For a second embodiment of the invention, the shaft of the spray tip assembly incorporates a pair of spaced apart nozzles and a handle at each end, one of which is removable for insertion into the spray tip housing. The tip housing has a bore that extends from one side thereof to the other so as to permit the shaft to axially slide between first and second positions, each of which is limited by one of the handles. At each position, the shaft may be rotated about its axis to select either a spraying position or a reversed, unclogging position for each nozzle.

A third embodiment of the invention utilizes a tip shaft having a single handle. A pair of nozzles are perpendicular to and spaced apart along the shaft axis, but are rotated 90 degrees with respect to one another. The tip shaft handle rides against a wobble plate around the periphery of a bore within the spray tip housing. The wobble plate imparts an axial shift to the shaft as it is rotated within the bore. A rotational position corresponding to zero degrees corresponds to the spray position for the first nozzle, a 90-degree position corresponds to the spray position for the second nozzle, a 180-degree position corresponds to the unclog position for the first nozzle, and a 270-degree position corresponds to the unclog position for the second nozzle. Thus, displacement of the tip shaft is the same for zero and 180-degree position, and the same for 90 and 270-degree positions. The end of the tip shaft opposite the handle may be spring biased so that the shaft handle automatically follows the wobble plate to ensure proper nozzle positioning in an axial direction. As an option, the wobble plate may be notched at the 0, 90, 180 and 270 degree locations, and the shaft handle equipped with a detent for precise rotational positioning of the shaft at the desired locations.

### BRIEF DESCRIPTION OF THE DRAWINGS

FIG. 1 is a right-side elevational view of a typical prior art spray gun for an airless paint sprayer system;

FIG. 2 is an enlarged right side elevational view of the spray tip assembly of the spray gun of FIG. 1, with the spray tip removed;

FIG. 3 is an isometric view of a prior art single-nozzle spray tip;

FIG. 4 is a top plan see-through view of the spray tip assembly of the spray gun of FIG. 1, with the spray tip removed;

FIG. 5 is a top plan view of the spray tip assembly of the spray gun of FIG. 1, with the spray tip of FIG. 3 installed therein;

FIG. 6 is a front elevational view of the spray tip assembly of the spray gun of FIG. 1, with the spray tip of FIG. 3 installed therein;

FIG. 7 is an isometric view of a three-nozzle spray tip manufactured in accordance with the present invention;

FIG. 8 is a top cross-sectional plan view of a first embodiment spray tip housing for use in combination with the spray tip of FIG. 7, taken through the axes of the cylindrical tip receiving bore and of the paint inlet opening;

FIG. 9 is a is a top cross-sectional plan view of a second embodiment spray tip housing for use in combination with the spray tip of FIG. 7, taken through the axes of the cylindrical tip receiving bore and of the paint inlet opening;

FIG. 10 is a side elevational view of the second embodiment spray tip housing of FIG. 9;

FIG. 11 is an isometric view of a partially-disassembled dual-nozzle spray tip having a handle at each end thereof, fabricated in accordance with the present invention;

FIG. 12 is an isometric view of the fully assembled dual-nozzle spray tip of FIG. 10;

FIG. 13R is a right side elevational view of a third embodiment spray tip housing for use in combination with the spray tip of FIGS. 10 and 11;

FIG. 13L is a left-side elevational view of the third embodiment spray tip housing of FIG. 13R;

FIG. 14 is an isometric view of a dual-nozzle spray tip in which each nozzle is rotated 90 degrees from the other; and

FIG. 15 is a fourth embodiment spray tip housing for use in combination with the spray tip of FIG. 13.

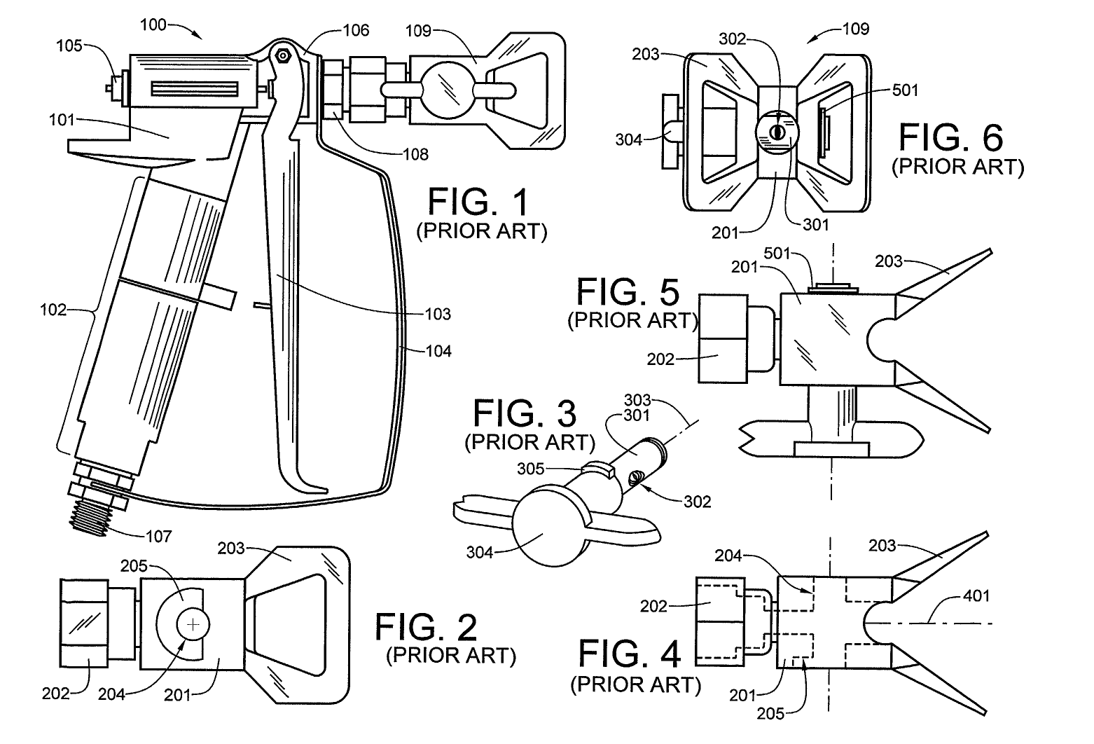

### DETAILED DESCRIPTION OF THE INVENTION

The present invention provides a new spray tip assembly that may be used in combination with prior art spray guns for airless paint sprayers. The spray tip assembly incorporates a tip having multiple nozzles, each of which may be used independently. Several embodiments of the invention are contemplated, each of which will now be described with reference to the attached drawing figures.

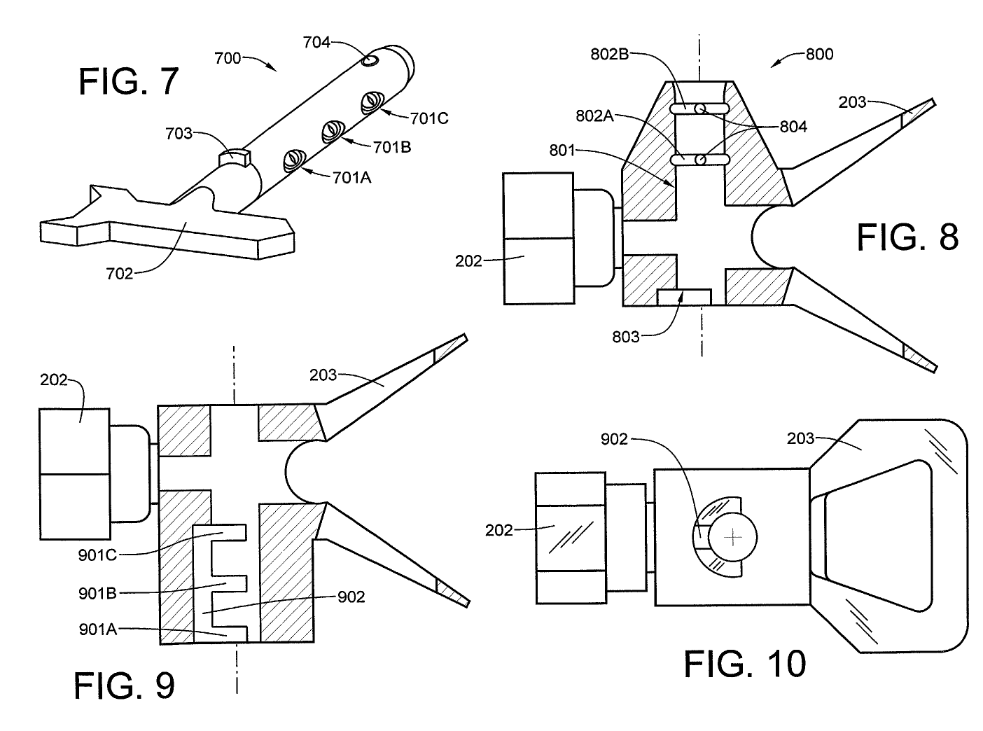

Referring now to FIG. 7, a first embodiment multiple-nozzle spray tip shaft 700 manufactured in accordance with the present invention incorporates three aligned, spaced apart nozzles 701A, 701B and 701C and a preferably non-removable handle 702 at one end thereof. The handle preferably incorporates a rotational stop tab 703. The shaft 700 may also incorporate a spring-loaded detent ball 704. The first embodiment spray tip shaft 700 may be used in combination with either the first embodiment spray tip housing 800 of FIG. 8 or the second embodiment spray tip housing 900 of FIGS. 9 and 10.

In the case of the combination of the first embodiment spray tip shaft 700 with the first embodiment housing 800, the housing has a bore 801 equipped with a plurality of spaced-apart annular or semi-annular grooves 802A and 802B, each of which, in conjunction with the spring-loaded detent ball 704, serves as a shaft locator for nozzles 701A and 701B, respectively. A semicircular recess 803, in combination with the handle 702 and rotational stop tab 703, serves to position nozzle 701C. The grooves 802A and 802B permit positioning of each of the nozzles 701A and 701B in either a normal spraying position or in a reversed, unclogging position. Each of the grooves 802A and 802B may have a pair of depressions 804 (only one of which is shown for each groove), that are somewhat deeper than the grooves 802 for indexing the spraying and unclogging positions of the shaft 700.

In the case of the combination of the first embodiment spray tip shaft 700 with the second embodiment housing 900, the housing incorporates three spaced-apart annular channels 901A, 901B and 901C, all three of which are interconnected by a passageway shaped to admit the stop tab 703. More accurately, the outermost channel 901A is really a semicircular recess, shown in the prior art description as item 205, as it is open on one side. The stop tab 703 may be indexed with one of the channels 901A, 901B or 901C, thereby serving to position the shaft 700 so that each of the nozzles 701A, 701B and 701C may be respectively and independently positioned for use in a normal orientation for spraying, or a reversed orientation for unclogging.

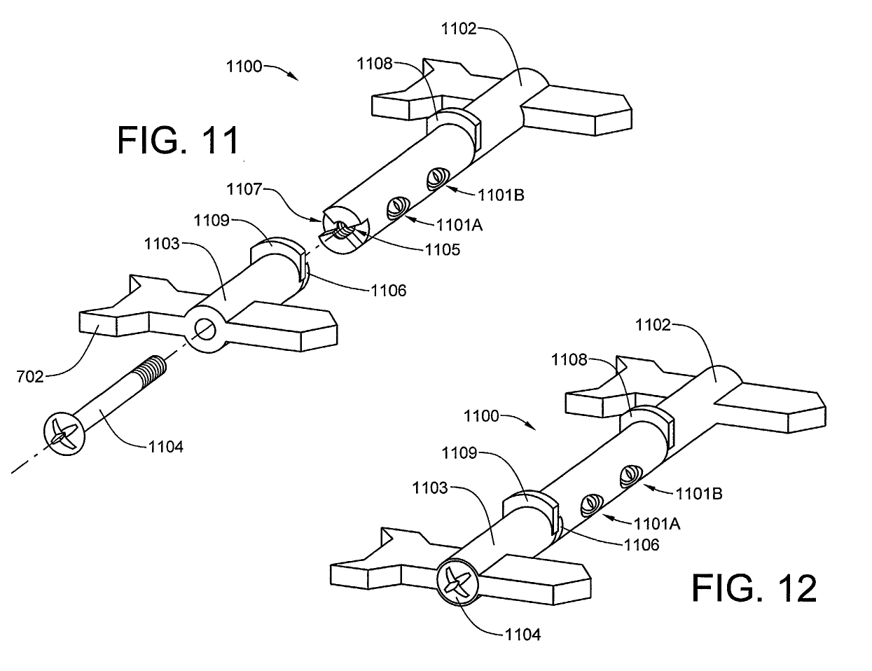

Referring now to FIG. 11, a second embodiment spray tip shaft 1100 incorporates a pair of spaced-apart nozzles 1101A and 1101B, a first handle 1102 permanently affixed to an end of the shaft 1100 and a second handle 1103 that is reversably attachable to the opposite end thereof. A machine screw 1104 engages an axially bored, threaded hole 1105 in an end of the shaft 1100. The removable second handle 1103 incorporates anti-rotational protrusions 1106 which engage recesses 1107 on the threaded end of the shaft 1100. It will be noted that each of the handles 1102 and 1103 incorporates a rotational stop tab 1109 and 1109, respectively.

Referring now to FIG. 12, the removable second handle 1103 has been attached to the spray tip shaft 1100.

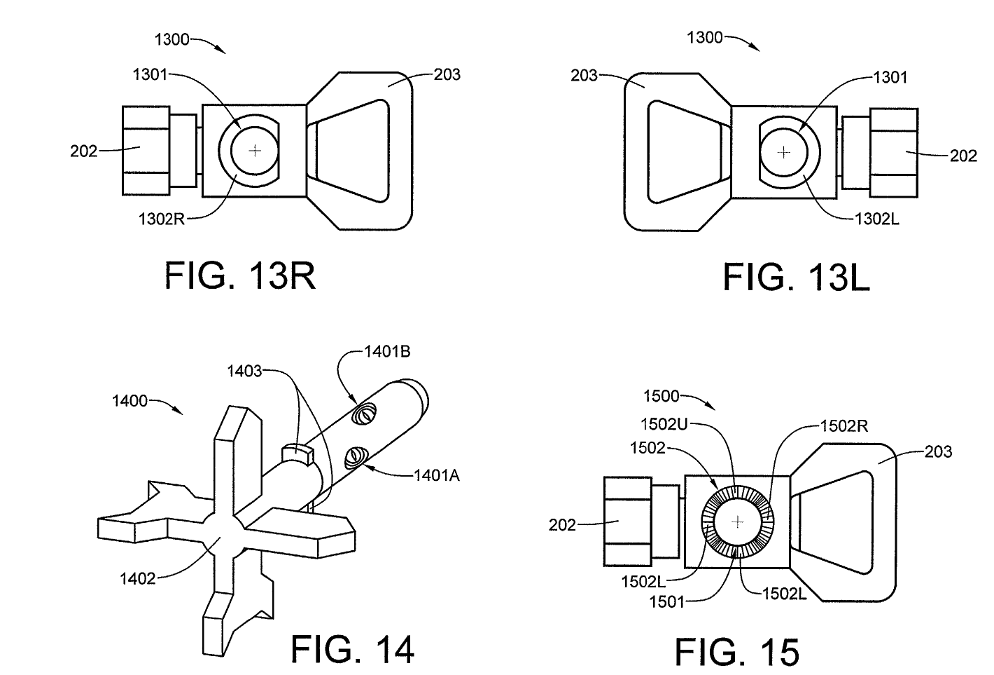

The second embodiment spray tip shaft 1100 is preferably used in combination with the third embodiment tip housing 1300 of FIGS. 13R and 13L. The tip housing 1300 has a bore 1301 that extends from one side thereof to the other so as to permit the shaft to axially slide between first and second positions, each of which is limited by one of the handles. It should be understood that attachment of the second handlel 1103 to the tip shaft 1100 is made after the tip shaft 1100 has been inserted within the bore 1301. The mouth at each side of bore 1301 is fitted with a semicircular recess 1302. The semicircular recess on the right side of the tip housing 1300 is identified as recess 1302R, while the semicircular recess on the left side is identified as recess 1302L. The shaft 1100 can be slid from side to side so that the stop tab on the handle adjacent the housing may ride within the recess. Thus, the shaft 1100 may be rotated about its axis to select, for each nozzle, either a normal position for spraying, or a reversed position for unclogging.

Referring now to FIG. 14, a third embodiment spray tip shaft 1400 includes a pair of spaced-apart nozzles 1401A and 1401B and a single handle 1402. Each of the nozzles 1401A or 1401B is rotated 90 degrees from the other nozzle. What appears to be a rotational stop tab on the handle is actually a wobble plate follower tab 1403. There are preferably two follower tabs 1403, rotationally spaced 180 degrees apart. One of the follower tabs 1403 is not completely visible in this view.

Referring now to FIG. 15, a fourth embodiment spray tip housing 1500 is intended to be used in combination with the third embodiment spray tip shaft 1400. The tip shaft 1400 is insertable within a bore 1501, the mouth of which is equipped with a wobble plate 1502, against which the follower tabs ride. The low topography portions of the wobble plate 1502 correspond to the upper and lower quadrants thereof (1502U and 1502L, respectively), while the high topography portions of the wobble plate 1502 correspond to the right and left quadrants thereof (1502R and 1502L, respectively). If the handle 1402 is rotated while pressing the shaft 1400 into the housing 1500, the wobble plate imparts an axial shift to the tip shaft 1400 as the follower tabs 1403 ride thereon, and the shaft 1400 will slide back and forth within the bore 1501. When the shaft 1400 is positioned for maximum insertion into the housing 1500, nozzle 1401A is selected either for spraying or unclogging. When the shaft 1400 is positioned for minimum insertion into the housing 1500, nozzle 1401B is selected either for spraying or unclogging. A rotational position corresponding to zero degrees corresponds to the spray position for the first nozzle 1401A, a 90-degree position corresponds to the spray position for the second nozzle 1401B, a 180-degree position corresponds to the unclog position for the first nozzle 1401A, and a 270-degree position corresponds to the unclog position for the second nozzle 1401B. Thus, displacement of the tip shaft is the same for zero and 180-degree position, and the same for 90 and 270-degree positions. The end of the tip shaft opposite the handle may be optionally spring biased so that the follower tabs 1403 automatically follow the wobble plate topography to ensure proper nozzle positioning in an axial direction. As an option, the wobble plate may be notched at the 0, 90, 180 and 270 degree locations, and each of the follower tabs 1403 equipped with a detent for precise rotational positioning of the shaft at the desired locations.

Although only several embodiments of the invention has been heretofore described, it will be obvious to those having ordinary skill in the art that changes and modifications may be made thereto without departing from the scope and the spirit of the invention as hereinafter claimed.

What is claimed is:

1. A spray tip assembly for use in combination with a spray gun of an airless paint spraying system, said tip assembly comprising multiple nozzles, each of which is usable independently of the other.

2. The spray tip assembly of claim 1, which further comprises:
a spray tip assembly housing having a bore perpendicular to a direction of escape for paint from the gun; and
a generally cylindrical tip shaft which incorporates the multiple nozzles, said nozzles being spaced apart from one another, said tip shaft being slidably insertable and rotatable within said bore.

3. The spray tip assembly of claim 2, which further comprises a handle attached to one end of said tip shaft, said handle facilitating the rotation of the shaft to reverse the direction of each nozzle within the spray tip assembly so that, if necessary, it may be unclogged, said handle also indicating whether the nozzle is pointed forward for spraying, or is reversed.

4. The spray tip assembly of claim 3, wherein said handle incorporates a rotational stop tab, which permits the shaft to be reversibly and axially rotated through one-half of a full revolution.

5. The spray tip assembly of claim 4, wherein said bore is equipped with multiple spaced-apart annular channels, all of which are interconnected by a passageway shaped to admit the stop tab, said stop tab being indexable with one of the channels, each channel being associated with the positioning of a single nozzle for independent use in both normal and reversed directions.

6. The spray tip assembly of claim 2, wherein said tip shaft incorporates a spring-loaded detent ball, and said bore is equipped with a plurality of spaced-apart annular or semi-annular radial grooves, each of which, in conjunction with the spring-loaded detent ball, serves as a shaft locator for one of said nozzles.

7. The spray tip assembly of claim 6, wherein each of said grooves permits positioning of each of the nozzles in either a normal spraying position or in a reversed, unclogging position.

8. The spray tip assembly of claim 2, which further comprises a handle affixed to each end of said tip shaft, at least one of which is removable for insertion of the shaft within said bore, and wherein said bore extends through said housing, and said shaft is slidable within the bore between first and second positions, each of said positions being fixed by contact of a handle with one side of said housing, and each of said positions accommodating a single reversable nozzle.

9. The spray tip assembly of claim 8, wherein each handle incorporates a rotational stop, which permits the shaft to be reversibly and axially rotated through one-half of a full revolution.

10. The spray tip assembly of claim 2, wherein said tip shaft incorporates a pair of nozzles which are perpendicular to and spaced apart along the shaft axis, but are rotated 90 degrees about said axis, with respect to one another, said shaft also having a handle attached at one end thereof, said handle facilitating the rotation of the shaft both for selecting one of said pair of nozzles and for reversing the direction of each nozzle for unclogging, said housing incorporating a wobble plate at the mouth of the bore against which the handle rides, said wobble plate imparting an axial shift to the shaft as it is rotated within the bore, said axial shift each of said nozzles to be individually selected and reversed.

11. The spray tip assembly of claim 10, wherein a rotational position corresponding to zero degrees corresponds to a spraying position for the first nozzle, a 90-degree position corresponds to a spraying position for the second nozzle, a 180-degree position corresponds to an unclogging position for the first nozzle, and a 270-degree position corresponds to an unclogging position for the second nozzle.

12. The spray tip assembly of claim 11, wherein said wobble plate is notched at the 0, 90, 180 and 270 degree locations, and the shaft handle equipped with a detent for precise rotational positioning of the shaft at the various spraying and unclogging locations.

13. A spray tip assembly for an airless paint sprayer gun, said tip comprising:
a housing mountable to the gun, said housing having a cylindrical bore perpendicular to an intended direction of spray output; and
a generally cylindrical tip shaft which incorporates multiple nozzles, each of which is usable independently of the other, said nozzles being spaced apart from one another, said tip shaft being slidably insertable and rotatable within said bore.

14. The spray tip assembly of claim 14, wherein each of the nozzles is reversible to facilitate unclogging.

15. The spray tip assembly of claim 14, which further comprises a handle attached to one end of said tip shaft, said handle facilitating the rotation of the shaft to reverse the direction of each nozzle within the spray tip assembly so that, if necessary, it may be unclogged, said handle also indicating whether the nozzle is pointed forward for spraying, or is reversed.

16. The spray tip assembly of claim 15, wherein said handle incorporates a rotational stop, which permits the shaft to be reversibly and axially rotated through one-half of a full revolution.

17. The spray tip assembly of claim 14, wherein said tip shaft incorporates a spring-loaded detent ball, and said bore is equipped with a plurality of spaced-apart annular or semi-annular radial grooves, each of which, in conjunction with the spring-loaded detent ball, serves as a shaft locator for selection and reversal of individual nozzles.

18. The spray tip assembly of claim 14, which further comprises a handle affixed to each end of said tip shaft, at least one of which is removable for insertion of the shaft within said bore, and wherein said bore extends through said housing, and said shaft is slidable within the bore between first and second positions, each of said positions being fixed by contact of a handle with one side of said housing, and each of said positions accommodating a single reversable nozzle.

19. The spray tip assembly of claim 18, wherein each handle incorporates a rotational stop, which permits the shaft to be reversibly and axially rotated through one-half of a full revolution.

20. The spray tip assembly of claim 14, wherein said tip shaft incorporates a pair of nozzles which are perpendicular to and spaced apart along the shaft axis, but are rotated 90 degrees about said axis, with respect to one another, said shaft also having a handle attached at one end thereof, said handle facilitating the rotation of the shaft both for selecting one of said pair of nozzles and for reversing the direction of each nozzle for unclogging, said housing incorporating a wobble plate at the mouth of the bore against which the handle rides, said wobble plate imparting an axial shift to the shaft as it is rotated within the bore, said axial shift each of said nozzles to be individually selected and reversed.

21. The spray tip assembly of claim 20, wherein a rotational position corresponding to zero degrees corresponds to a spraying position for the first nozzle, a 90-degree position corresponds to a spraying position for the second nozzle, a 180-degree position corresponds to an unclogging position for the first nozzle, and a 270-degree position corresponds to an unclogging position for the second nozzle.

22. The spray tip assembly of claim 21, wherein said wobble plate is notched at the 0, 90, 180 and 270 degree locations, and the shaft handle equipped with a detent for precise rotational positioning of the shaft at the various spraying and unclogging locations.
